(19) United States
(12) Patent Application Publication
(10) Pub. No.: US 2005/0063409 A1
(43) Pub. Date: Mar. 24, 2005

(54) Method and apparatus for managing multicast delivery to mobile devices involving a plurality of different networks

(75) Inventor: Paul Oommen, Irving, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/665,812

(22) Filed: Sep. 18, 2003

(51) Int. Cl. H04J 3/26

(52) U.S. Cl. 370/432; 370/390

(57) ABSTRACT

A data communications system includes a plurality of different networks coupled together by communication links, and further includes at least one multicast agent for coupling a multicast message transmission from a first network to a second network. The multicast agent operates to modify the multicast message transmission from a multicast protocol of the first network to a multicast protocol of the second network. The first network may be an IP network, such as a wireless IP network, and the second network may be a non-IP network, such as WLAN or a Bluetooth network. There may be at least one mobile host coupled to the second network for receiving the multicast message transmission from the multicast agent. There may be multiple intermediate networks coupled between a multicast message server and receiving mobile devices.

### TECHNICAL FIELD

This invention relates generally to data communication networks operable with mobile devices or hosts and, more specifically, relates to techniques for providing multicast message delivery to mobile hosts in a wireless data communications network.

### BACKGROUND

Some current and future mobile data and message network services require sending the same integral unit of data simultaneously to a plurality of mobile hosts such as, for example, cellular telephones and/or PDAs having wireless (e.g., IR or RF) communications capability. This is referred to as a “multicast” type of operation. A typical multicast operation may include sending data associated with the provisioning of a service, as well as data associated with management during the life cycle of a service. Services typically require sending of data to mobile hosts in real time. Data is also typically sent when the service is updated. As may be appreciated, establishing a separate end-to-end delivery session for each mobile host would adversely affect the performance and throughput of networks in the end-to-end path that route the data, as well as in the air interface between the network and individual ones of the mobile hosts.

Current practice delivers data to mobile hosts using low data rate services such as OTA teleservices or PUSH, which can be implemented using short message service (SMS) techniques, or by using circuit switched or packet switched end-to-end methods that require a separate connection for each mobile host (a point-to-point approach). However, as the use of mobile hosts becomes more widespread, and as more and different types of networks are encountered in the end-to-end path between the source of the data and mobile hosts, the current techniques will prove to be inefficient with regard to the use of network bandwidth and throughput.

Conventional multicast protocols specified for Internet Protocol (IP) and mobile IP applications generally take into consideration only the core network and the wireless IP network. Examples of such IP-based protocols include DVMRP (Distance Vector Multicast Routing Protocol), MOSPF (Multicast Extensions to Open Shortest Path First) and PIM-DM (Protocol Independent Multicast-Dense Mode). The inventor is not aware of a protocol that is currently defined for multicast management across disparate network types.

In a wireless network environment a mobile host may not be attached at all times to the same network, and the existing multicast routing protocols do not address this situation. For mobile services envisioned for the future, many networks may potentially be involved in routing service-related data to mobile hosts. While the existing IP-based multicast routing protocols, such as those referred to above, can be used for routing within IP networks, there is at present no generic mechanism to manage multicast routing in any network. For example, there is currently no generic mechanism to manage the multicast routing of the data sent from the wireless network and routed through an access network, such as a Bluetooth network.

Representative U.S. Patents that relate to multicast operation with mobile hosts include U.S. Pat. No. 6,477,149 B1, “Network System and Method of Controlling Multicast Group Participation of Mobile Host”, Okanoue; U.S. Pat. No. 6,418,138 B1, “Internet Radio Communication System”, Cerf et al.; U.S. Pat. No. 6,243,758 B1, “Internetwork Multicast Routing Using Flag Bits Indicating Selective Participation of Mobile Hosts in Group Activities Within Scope”, Okanoue; and U.S. Pat. No. 6,240,089 B1, “Method of Multicasting for Mobile Host Used in Any One of Subnetworks Connected to One Another”, Okanoue et al.

The foregoing U.S. Patents do not cure the existing deficiencies in mobile host multicast routing protocols with regard to the routing of data through a plurality of different network-types.

### SUMMARY OF THE PREFERRED EMBODIMENTS

The foregoing and other problems are overcome, and other advantages are realized, in accordance with the presently preferred embodiments of these teachings.

This invention presents an efficient multicast delivery method that is suited for use with mobile hosts in the case where multiple different types of networks (e.g., a hybrid network such as an IP network and a non-IP network) are involved in the routing of data. The preferred embodiment of this invention employs management protocol agents and management agents that are distributed through the networks, in particular at discontinuities between networks.

This invention provides a method for managing multicast delivery of data to mobile devices in a network environment where there are a plurality of networks located in the end-to-end path. Since over-the-air (OTA) multicast management techniques should take into consideration the core network, the access network requirements, as well as other networks, such as a Bluetooth network, in the end-to-end path, this invention provides multicast management agents in mobile device and network components, where the multicast management agents are located at discontinuities in the end-to-end delivery path.

A data communications system in accordance with this invention includes a plurality of different networks coupled together by communication links, and further includes at least one multicast agent for coupling a multicast message transmission from a first network to a second network. The multicast agent operates to modify the multicast message transmission from a multicast protocol of the first network to a multicast protocol of the second network. There may be one or more intermediate networks in the path between a multicast server network and a multicast receiver access network.

The first network may comprise an IP network, such as a wireless IP network, and the second network may comprise a non-IP network, such as WLAN or a Bluetooth network.

In the preferred embodiment there is at least one mobile host coupled to the second network for receiving the multicast message transmission from the multicast agent.

Also disclosed is a method to simultaneously send a message to a plurality of mobile hosts through a plurality of different networks. The method includes: (a) initiating a multicast session with the plurality of mobile hosts with a multicast server that is coupled to a first network; (b) receiving a multicast message transmission for the plurality of mobile hosts with at least one multicast agent located in the first network; (c) modifying with the at least one multicast agent the multicast message transmission from a multicast protocol of the first network to a multicast protocol of a second network; and (d) delivering the multicast message transmission, in the second multicast protocol, to those mobile hosts that are wirelessly coupled to the second network.

Further in accordance with this invention there is provided a system and method to simultaneously send a message from a server coupled to an end network, via at least one intermediate network, to a plurality of mobile devices coupled to the at least one intermediate network through a plurality of access networks, such as mobile device access networks. The method includes: (a) setting up a multicast session between the server and the plurality of mobile devices via the end network, the at least one intermediate network, a plurality of the access networks, and a plurality of agents coupled between the end network and the at least one intermediate network, and between the at least one intermediate network and the plurality of access networks; (b) receiving a multicast transmission at an agent coupled between at least one access network and the at least one intermediate network; and (c) directing the multicast transmission only to an access network or access networks where the agent has knowledge of at least one mobile device that is to receive the multicast transmission. In the presently preferred embodiment directing the multicast transmission includes modifying with the at least one agent the multicast transmission from a protocol of the network that the multicast transmission was received from to a protocol of the network that the multicast transmission is to be directed to. The method further includes delivering the multicast transmission to the plurality of mobile devices, using a protocol appropriate for each access network to which the plurality of mobile devices are attached.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a diagram showing the use of agents at different intermediate networks for the management of end-to-end multicast delivery in a hybrid network;

FIG. 2 depicts an example of a hybrid network involving Wireless IP, a Radio Access Network (RAN) and a Wireless Local Area Network (WLAN);

FIG. 3 depicts an example of a hybrid network involving Wireless IP, Radio Access Network and a Bluetooth network;

FIG. 4 shows an example of a 1×EV-D0 system session protocol stack;

FIG. 5 shows a hierarchical arrangement of networks of different network types, with multiple instances of networks of the same type; and

FIG. 6 illustrates a network environment containing access networks, intermediate networks, and an end network, and is useful when explaining the setting up of a multicast path.

### DETAILED DESCRIPTION OF THE PREFERRED EMBODIMENTS

Reference is made to FIG. 1 for showing a diagram of a hybrid network 10 composed of an exemplary number of networks 12, 14 and 16, also referred to as Network A, Network B and Network C, respectively. A mobile host 18, such as a cellular telephone or a PDA, communicates in a wireless manner with network 16 via a suitable transceiver 18A and, for the case of an RF connection, an antenna 18B.

In accordance with this invention there are also a plurality of agents 20A, 20B, 20C and 20D (collectively referred to as agents 20) that are associated with Network A, Network B, Network C and the mobile host 18, respectively. The agents 20 located at the different intermediate networks (Network A, Network B, Network C) provide for the management of end-to-end multicast delivery in the hybrid network 10 As but one example, Network C may be a Bluetooth network, Network B may be a wireless IP network, and Network A may be a wired IP network. In this architecture, each network has at least one of the agents 20 associated therewith to manage the multicast session with the mobile host 18 (other mobile hosts (not shown) are assumed to also be present). Between each network corresponding protocols are preferably used to establish a single path for the multicast session.

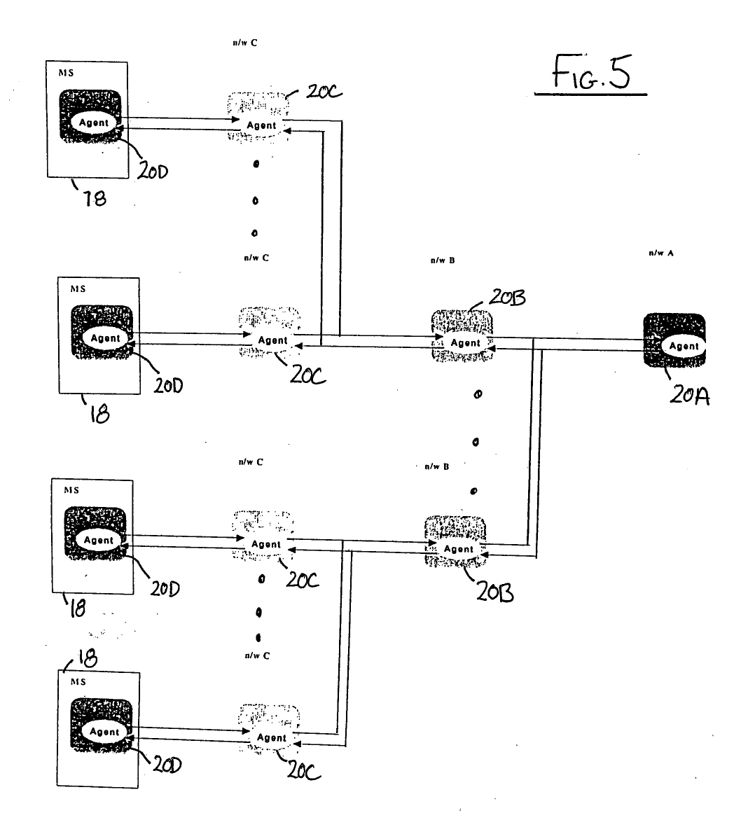

For example, FIG. 4 shows a 1×EV-D0 system session protocol stack. In FIG. 4 the user device corresponds to the mobile host 18 and the BTS is a Base Transceiver Station to which the mobile host 18 is wirelessly connected through the 1×EV-DO airlink. The higher protocol layers include RLP, which is a Radio Link Protocol layer; PPP, which is a Point-to-Point Protocol layer; TCP, which is the Transmission Control Protocol layer; and UDP, or the User Datagram Protocol layer. In this type of environment certain ones of the agents 20 may employ a Generic Routing Encapsulation (GRE) protocol for sending data between a Packet Data Serving Node (PDSN) and the Packet Control Function (PCF), which may be associated with the Base Station Controller (BSC), while OTA signaling may be used between the agent 20D of the mobile host 18 and the BSC, via the BTS. Thus, for all mobile hosts 18 served by a single PCF, there will be only one session between the PCF and the PDSN. Similarly, from the originating server to a PDSN, there will only one session.

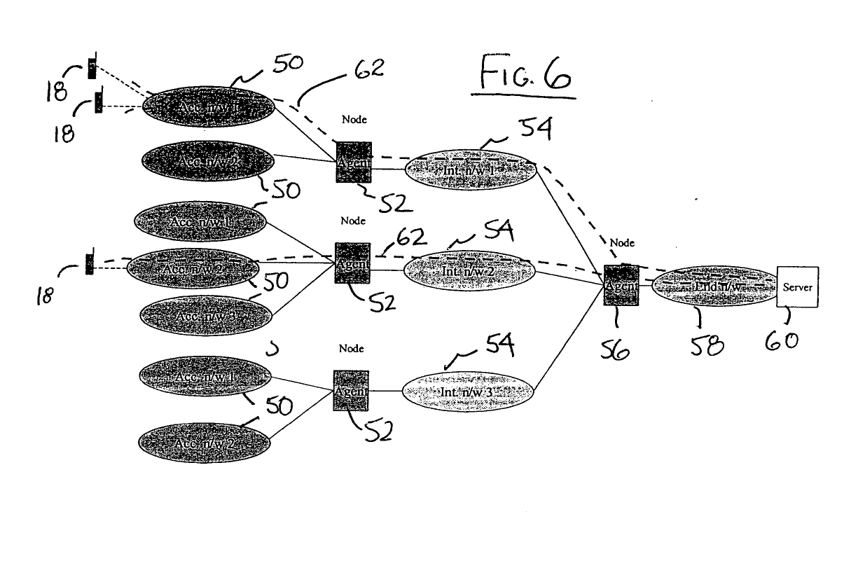

At the beginning of a multicast session there is typically a service discovery process whereby the mobile host 18 is informed about the availability of a particular service. In a group establishment phase, a plurality of mobile hosts 18 enroll or register for a particular service, which requires delivery of data using multicast methods to the mobile hosts 18. The OTA management agent 20D in the mobile host 18 initiates the session by sending the multicast parameters (multicast profile) to the peer agent in the serving network, such as the agent 20C, or one of the agents 20B or 20A, depending on the location of the server that provides the service. This server can reside in a non-IP network, and the message can be sent over the transport protocol supported between the mobile host 18 and the network. In the example of FIG. 1, each mobile host 18 desiring the offered service sends a message to its serving Network C, it being realized that there will typically be a plurality of Networks C serving a number of mobile hosts 18, by the same or different air interface standards. There may be more networks in the end-to-end path. All networks of type C, which have mobile hosts 18 joined for the service send a message to the Network B. And all Networks of type B, which receive the message, send a message the agent 20A in Network A. As is shown in FIG. 5, in a typical case there may be multiple instances of Network B (n/w B) linked to Network A (n/w A), and multiple instances of Network C (n/w C) linked to each Network B. The message, which originates from the mobile host 18, is thus migrated to the originating server (that is assumed to reside in Network A in this example), and during this migration the multicast path is setup across the different networks under control of the agents 20. After authenticating the mobile host 18, based on credentials provided in the message, the server sends the data in the multicast forward path towards the various mobile hosts 18 that are enrolled to receive the desired service.

As was noted above, existing multicast solutions only consider one type of network, the IP network. Such multicast protocols are designed for clients (devices) in the IP network to join a multicast group, and the IP routers establish the multicast path from the server to the client. When there are non-IP networks in the path (or a combination of different types of networks), the existing IP multicast solutions are inadequate for managing a multicast session.

This invention solves this problem, by distributing the agents 20 so as to provide a multicast interface between different networks, enabling the unimpeded flow of multicast data between networks and between the mobile host(s) 18 and the originating server.

Some examples of multiple networks in the end-to-end path are now provided.

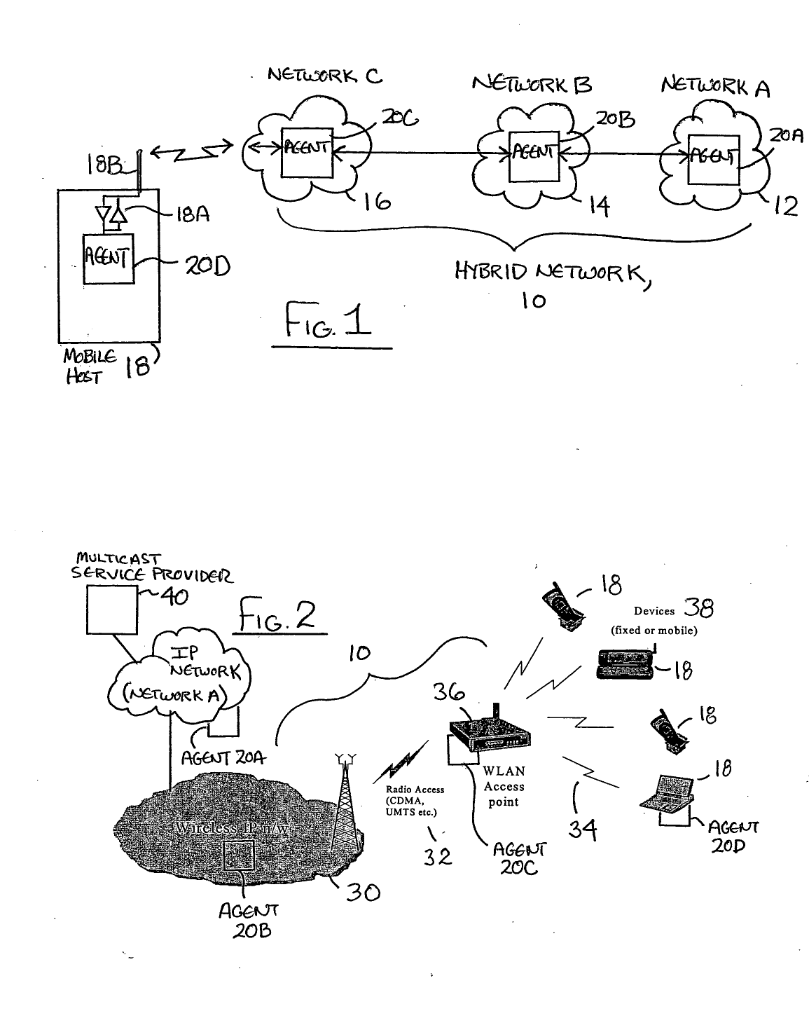

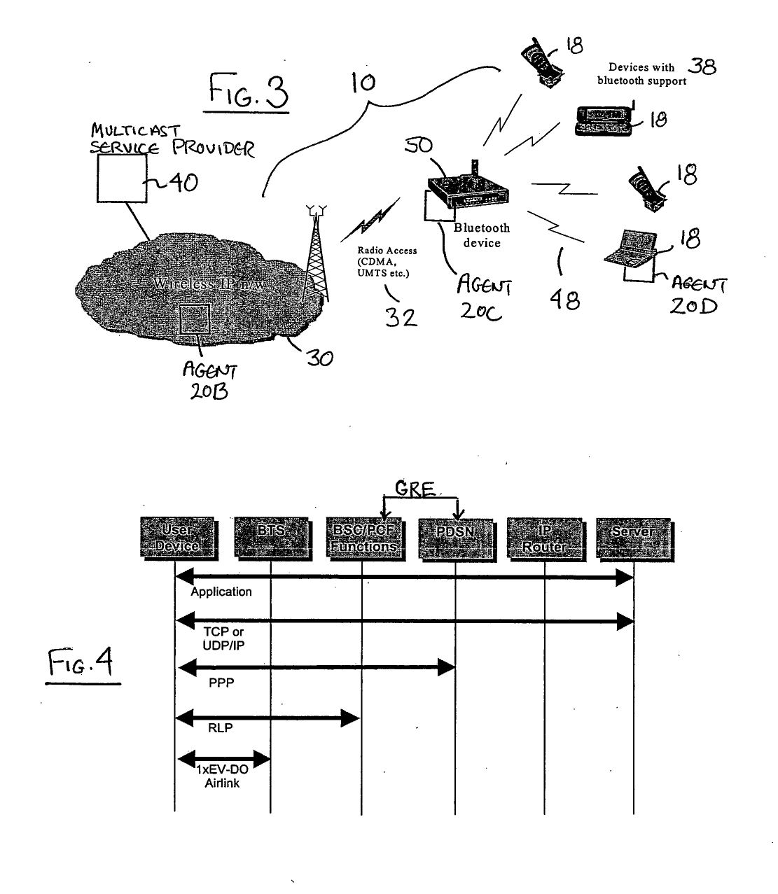

FIG. 2 shows an example of the hybrid network 10 that includes a Wireless IP network 30, a Radio Access Network (RAN) 32 and a Wireless Local Area Network (WLAN) 34 that includes a WLAN access point 36. For example, the WLAN access point 36 can be located aboard a cruise ship, a bus or some other means of transportation, and users of the WLAN 34 access same using the WLAN access point 34. The WLAN access point 34 is connected to the wireless IP network 30 over, as an example, a CDMA (high speed link such as CDMA 1×EV-DV or 1×EV-DO) or via an UMTS air interface 32, or any other air interface providing connectivity to the wireless IP network 30. The users are shown as having a plurality of different types of devices 38, which can be fixed hosts or mobile hosts 18 (e.g., lap top computers, cellular telephones and PDAs).

In this scenario a service provider 40 (a provider of a multicast service) in an IP network (e.g., the Network A or in the wireless IP network 30) announces the availability of a multicast service. Each device 38 discovers the multicast service, and has the opportunity to join the multicast session. To join the multicast group, the agent 20D located in a mobile hosts 18 sends the multicast profile information to a peer agent 20C located in the WLAN access point 36. This information is exchanged to the wireless IP network 30 over the air interface 32. The multicast manager (which can form part of the multicast service provider 40) in the IP Network or in the Wireless IP Network 30 uses the profile to establish multicast delivery session with all access points that have at least one device 38 joining the session.

FIG. 3 depicts another example of the hybrid network 10 that includes the Wireless IP network 30, the RAN 32 and a Bluetooth Network 48 that includes a Bluetooth device 50 as the access point. In this embodiment the mobile devices 18 are assumed to include Bluetooth communication capability. In this embodiment the intermediate Bluetooth device 50 is notified by the multicast service provider 40 (assumed in this example to be embodied in the Wireless IP network 30) of a multicast service. The Bluetooth device 48 notifies devices 38 with Bluetooth support in its vicinity of the availability of the multicast service, using a suitable current or future Bluetooth multicast protocol. Each device 38 in the vicinity of the Bluetooth device 50 is enabled to join the multicast session. The agent 20D in the mobile host 18 sends its multicast profile to the peer agent 20C in the Bluetooth device 50. The Bluetooth device 50 then sends the information to the multicast service provider 40 in the Wireless IP network 30 over the RAN 32.

As can be appreciated, the multicast agents 20 function in a manner that is somewhat analogous to a protocol converter, and beneficially adapt a received multicast transmission into the multicast protocol format required by its associated network. The agents 20 may detect that that a received transmission from an attached network (towards the multicast service provider 40) is a multicast message, or is related to a multicast message, by information included in the packet header. Thus, by examining received packet headers the agents 20 are enabled to detect that a multicast session is being initiated, or is in progress, and thus adapt the received packet(s) to the local multicast protocol for the applicable network in the direction towards the mobile host 18.

FIG. 6 illustrates a further embodiment of this invention, where there exist a plurality of access networks (Acc n/w) 50 each coupled to a node comprising an agent 52. Each agent 52 is coupled to an intermediate network (Int. n/w) 54, each of which is coupled in turn to a further node comprising an agent 56. The agent 56 is coupled to a server 60 via an end network (End n/w) 58. Note that there could be multiple intermediate networks 54 in series between an agent 52 and an agent 56, and at a node between each intermediate network there may be another one of the agents. The dashed lines 62 in FIG. 6 indicate examples of possible multicast paths. Initially the server 60 announces a multicast service to all devices, and it assumed that only a few mobile users 18 decide to join a service. Consequently the client in the mobile device 18 sends a message to the server 60 in the end network 58 to join or enroll in the group. Consider now the agent 52 located at the node (or discontinuity) between Access n/w 50 and the Intermediate n/w 54. When the agent 52 receives the message originating from a client mobile device 18 to join the group, the agent 52 maintains the state regarding (records the identity of) which Access n/w 50 has at least one mobile device 18 joining the multicast group. Also, the agent 50 directs the message to the next agent 56 in the reverse path (i.e., from client mobile device 18 towards the server 60). The agent 60 also maintains the state regarding which networks in the forward path have a possible multicast path. In the example shown in FIG. 6 only the Intermediate networks 1 and 2 have such a path, while the Intermediate n/w 3 does not have a path leading to an Access n/w 50 with at least one mobile device 18 that is joined to or a member of the multicast group. This can be considered to be an initial setup phase, where agents 52 and 56 maintain the state regarding possible multicast paths, using messaging.

After this initial setup phase, when multicast data originating from the server 60 arrives at a node, the associated agent 52, based on the state, know that the data should be directed only to the Access network or networks 50 having at least one mobile device 18 that is part of the multicast group. This prevents the agents 52 from sending the same data to all Access networks 50, including those that do not have a mobile device 18 connected thereto that is a member of the multicast group. This approach thus clearly reduces unnecessary data transmissions, and conserves network bandwidth.

The same mechanism is applicable between an Intermediate n/w 54 and the End n/w 58, i.e., the agent 56 at the node between these two networks sends the data originating from the server 60 only to an Intermediate n/w 54 having a path to an Access n/w 50 having a mobile device 18 that previously enrolled to receive the multicast data.

The agents 52, 56 can thus be seen to aid in setting up the path between the networks of different type, as well to manage the multicast delivery.

In a typical implementation of this invention the messaging between client to agent, agent to agent, agent to server and so forth can be based on any one or more of, as examples, a SyncML DM protocol, WAP, XML, or, in general, any possible messaging protocol supported between networks.

It should be noted that the networks at each level, for example the access networks 50 and/or the intermediate networks 54, need not be of the same kind or network type. The agents 52, 56, and the management mechanism executed by and through the agents 52, 56, aids in managing the multicast delivery in such a heterogeneous network environment.

As but one example, at least one access network 50 could comprise a cdma network (e.g., a WCDMA or a cdma2000 network), at least one other access network 50 could comprises a wireless local area network (WLAN), at least one other access network comprises a low power RF network, such as a Bluetooth network; and at least one other access network could comprise an infrared optical network.

In a presently preferred embodiment the agents 20, 52 and 56 may be implemented as software that runs on a data processor of the network node where the agent is resident (e.g., an agent 20 may run on a data processor of the mobile host 18, or on a data processor associated with or coupled to the BSC of the Wireless IP network 30).

The foregoing examples are not limiting of this invention, as these teachings can be used to manage a multicast session in any possible current or future network combination, not limited to Wireless IP, WLAN or Bluetooth networks. The teachings of this invention can also be used for managing multicast sessions involving a number of different types of wireless networks, such as GSM, cdma2000 (e.g., 1×EV-DV or 1×EV-DO networks) and GPRS networks.

One non-limiting example of the use of this invention is in rapidly updating software in an installed base of mobile devices 18, such as mobile hosts, whereby a multicast session is used to simultaneously send the update to a plurality of the mobile devices 18 from a network server (e.g., the server 60 of FIG. 6) that is not resident in the possibly large number of different types of wireless access networks (e.g., Access networks 50) to which the installed base of mobile hosts 18 is connected with.

While this invention has been described in the context of presently preferred embodiments, it is possible that those skilled in the art may derive various changes to the teachings of this invention, when guided by the foregoing disclosure. However, all such changes and modifications should be found to fall within the scope of the teachings of this invention, and are subsumed thereby.

1. A data communications system comprising a plurality of different networks coupled together by communication links, further comprising at least one multicast agent for coupling a multicast message transmission from a first network to a second network, said at least one multicast agent modifying the multicast message transmission from a multicast protocol of the first network to a multicast protocol of the second network.

2. A data communications system as in claim 1, where said first network comprises an IP network, and where said second network comprises a non-IP network.

3. A data communications system as in claim 1, where said first network comprises a wireless IP network, and where said second network comprises a non-IP network.

4. A data communications system as in claim 1, where said first network comprises a wireless IP network, and where said second network comprises a wireless local area network (WLAN).

5. A data communications system as in claim 1, where said first network comprises a wireless IP network, and where said second network comprises a Bluetooth network.

6. A data communications system as in claim 1, further comprising at least one mobile host coupled to said second network for receiving the multicast message transmission from said multicast agent.

7. A method to operate a data communications system comprising a plurality of different networks coupled together by communication links, comprising initiating a multicast session from a multicast server coupled to a first network; receiving a multicast message transmission from the multicast server with at least one multicast agent located in the first network; and modifying with the at least one multicast agent the multicast message transmission from a multicast protocol of the first network to a multicast protocol of a second network.

8. A method as in claim 7, where said first network comprises an IP network, and where said second network comprises a non-IP network.

9. A method as in claim 7, where said first network comprises a wireless IP network, and where said second network comprises a non-IP network.

10. A method as in claim 7, where said first network comprises a wireless IP network, and where said second network comprises a wireless local area network (WLAN).

11. A method as in claim 7, where said first network comprises a wireless IP network, and where said second network comprises a Bluetooth network.

12. A method as in claim 7, further comprising receiving the multicast message transmission from said multicast agent with at least one mobile host coupled to said second network.

13. A method to simultaneously send a message to a plurality of mobile hosts through a plurality of different networks, comprising initiating a multicast session with the plurality of mobile hosts with a multicast server coupled to a first network; receiving a multicast message transmission for the plurality of mobile hosts with at least one multicast agent located in the first network; modifying with the at least one multicast agent the multicast message transmission from a multicast protocol of the first network to a multicast protocol of a second network; and delivering the multicast message transmission, in the second multicast protocol, to those mobile hosts that are wirelessly coupled to the second network.

14. A method as in claim 13, where said first network comprises an IP network, and where said second network comprises a non-IP network.

15. A method as in claim 13, where said first network comprises a wireless IP network, and where said second network comprises a non-IP network.

16. A method as in claim 13, where said first network comprises a wireless IP network, and where said second network comprises a wireless local area network (WLAN).

17. A method as in claim 13, where said first network comprises a wireless IP network, and where said second network comprises a Bluetooth network.

18. A method as in claim 13, where there are a plurality of said second networks coupled to said first network, each of said second networks comprising one of said multicast agents.

19. A method to simultaneously send a message from a server coupled to an end network, via at least one intermediate network, to a plurality of mobile devices coupled to the at least one intermediate network through a plurality of access networks, comprising setting up a multicast session between the server and the plurality of mobile devices via the end network, the at least one intermediate network, a plurality of the access networks, and a plurality of agents coupled between the end network and the at least one intermediate network, and between the at least one intermediate network and the plurality of access networks; receiving a multicast transmission at an agent coupled between at least one access network and the at least one intermediate network; directing the multicast transmission only to an access network or access networks where the agent has knowledge of at least one mobile device that is to receive the multicast transmission; where directing includes modifying with the at least one agent the multicast transmission from a protocol of the network that the multicast transmission was received from to a protocol of the network that the multicast transmission is to be directed to; and delivering the multicast transmission to the plurality of mobile devices, using a protocol appropriate for each access network to which the plurality of mobile devices are attached.

20. A method as in claim 19, where at least one network comprises an IP network.

21. A method as in claim 19, where at least one network comprises a non-IP network.

22. A method as in claim 19, where at least one access network comprises a wireless IP network.

23. A method as in claim 19, where at least one access network comprises a non-IP network.

24. A method as in claim 19, where at least one access network comprises a wireless local area network (WLAN).

25. A method as in claim 19, where at least one access network comprises a Bluetooth network.

26. A method as in claim 19, where at least one access network comprises a cdma network.

27. A method as in claim 19, where at least one access network comprises a low power RF network.

28. A method as in claim 19, where at least one access network comprises one of a wired or a wireless access network.

29. A method as in claim 19, where at least one access network comprises an infra red optical network.

30. A method as in claim 19, where there are a plurality of said access networks coupled to an intermediate network via a first agent, and where said intermediate network is coupled to said end network via a second agent, and where each agent records an identity of a network or networks coupled thereto having at least one mobile device that has enrolled to become part of the multicast session during the set up process, and where each agent directs a received multicast transmission only to a recorded network or networks.

31. A method as in claim 19, where messaging between networks is based on a SyncML DM protocol, WAP, XML, or any messaging protocol supported between networks.

32. A system to simultaneously send a message from a server coupled to an end network, via at least one intermediate network, to a plurality of mobile devices coupled to the at least one intermediate network through a plurality of access networks, comprising means for setting up a multicast session between the server and the plurality of mobile devices via the end network, the at least one intermediate network, a plurality of the access networks, and a plurality of agents coupled between the end network and the at least one intermediate network, and between the at least one intermediate network and the plurality of access networks; at an agent coupled between at least one access network and the at least one intermediate network, a receiver for receiving a multicast transmission and a transmitter for directing the multicast transmission only to an access network or access networks where the agent has knowledge of at least one mobile device that is to receive the multicast transmission; said agent further comprising means for modifying with the at least one agent the multicast transmission from a protocol of the network that the multicast transmission was received from to a protocol of the network that the multicast transmission is to be directed to for delivering the multicast transmission to the plurality of mobile devices, using a protocol appropriate for each access network to which the plurality of mobile devices are attached.

33. A system as in claim 32, where at least one network comprises an IP network.

34. A system as in claim 32, where at least one network comprises a non-IP network.

35. A system as in claim 32, where at least one access network comprises a wireless IP network.

36. A system as in claim 32, where at least one access network comprises a non-IP network.

37. A system as in claim 32, where at least one access network comprises a wireless local area network (WLAN).

38. A system as in claim 32, where at least one access network comprises a Bluetooth network.

39. A system as in claim 32, where at least one access network comprises a cdma network.

40. A system as in claim 32, where at least one access network comprises a low power RF network.

41. A system as in claim 32, where at least one access network comprises one of a wired or a wireless access network.

42. A system as in claim 32, where at least one access network comprises an infra red optical network.

43. A system as in claim 32, where messaging between networks is based on a SyncML DM protocol, WAP, XML, or any messaging protocol supported between networks.

44. A system as in claim 32, where there are a plurality of said access networks coupled to an intermediate network via a first agent, and where said intermediate network is coupled to said end network via a second agent, and where each agent comprises memory for storing an identity of a network or networks coupled thereto having at least one mobile device that has enrolled to become part of the multicast session during the set up process, and where each agent transmits a received multicast transmission only to a network or networks having its identity stored in said memory.
